(19) United States
(12) Patent Application Publication
(10) Pub. No.: US 2014/0279288 A1
(43) Pub. Date: Sep. 18, 2014

(54) METHOD AND SYSTEM FOR DATA AGGREGATION AND DIFFUSION

(71) Applicant: Suzanne Small WOUK, Santa cruz, CA (US)

(72) Inventor: Suzanne Small WOUK, Santa cruz, CA (US)

(21) Appl. No.: 13/844,556

(22) Filed: Mar. 15, 2013

(51) Int. Cl. G06Q 30/06; G06K 9/78

(52) U.S. Cl. CPC G06Q 30/0643; G06K 9/78
USPC 705/27.2

(57) ABSTRACT

A system and method are provided for enabling evaluation of physical articles. An owner or other party generates video and/or still digitized images of one or more articles. An at least partially automated system analyzes the digitized images and provides evaluation and identification thereof. Third party evaluations of the digitized images may be sought and received, possibly by crowd sourcing. One or more third parties may be solicited for estimates of the quality and/or market value of articles. The system and method may provide graphical guidance for positioning an article for digitized image capture and rendered display. The system and method may advise the seller regarding ecommerce auction vendor selection. Audio and/or textual input may be associated with an article by the seller. The system and method may provide access to shipping services.

### FIELD OF THE INVENTION

The present invention relates to information technology applied to document and organize visual and textual information related to describing physical objects. More specifically, but not stated as limitations, embodiments of the present invention relate to capturing digitized images of objects for use access and diffusion by means of information technology systems and via electronic communications networks.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The availability of access to the Internet has generated wide spread access to services provided through over mobile phones, personal computers and/or via the World Wide Web, or “web services”. In addition, reduction in cost of storage of digitized information has been responded to by the provision of effective and useful web services for storing personal data and information of personal relevance. Yet a key weakness of the prior art is found in the limited techniques, tools and utilities made available to account holders of social networking services, and other web services, to harvest and organize digitized image information derivable from digitized images of objects and pluralities of objects, to include information derivable from digitized video files, for later access, analysis, reference, and benefit by the account holder.

The expansion of the Internet increasingly enables the storage and relating of massive amounts of information about entities to and about even the casual user. In particular, the marketing and sales of individual objects, possessions and licenses by individuals has been empowered by auction web sites like EBAY™, EBID™ and OVERSTOCK™ and by more traditional pricing online retailers, e.g., AMAZON™. The prior art, however, fails to provide optimized methods and systems that can efficiently and effectively enable potential sellers of objects, possessions and licenses to post a visual image of and associated information about items intended for sale via the Internet or other electronics communications networks. Nor does the prior art provide services that forecast and inform users of opportunities and options on the basis of the analysis of information related to the material possessions of participating members.

There is therefore a long felt need to provide systems and methods that enable users to provide digitized images of physical objects to an information technology system and to access information related to the physical objects.

### SUMMARY AND OBJECTS OF INVENTION

It is an object of the invented method to provide a method and a system that offer improvements in the process of gaining from the informational value of digitized images of items and the relatedness of these items to other items and persons via an electronics communications network, such as the Internet.

Towards these objects and other objects that will be made obvious in light of this disclosure, a system and method are provided for enabling the generation or acquisition of information about an items. both physical and intangible, and providing access to this information via the electronics communications network.

In one aspect of the method of the present invention (hereinafter, “invented method”) a web service accepts digitized image data and attempts to distinguish one or more individual physical objects from the digitized image data. The digitized image data may comprise or be comprised within single frame still images or video data. Image recognition technology and the use of human evaluators may be used in the identification of objects from analysis and viewing of the digitized image data. The web service may assign various identifying and descriptive information to an identified object, to include assigning or associating a type of object, make, model, manufacturer, brand, part number, year of release or manufacture, international standard book number (hereinafter, “ISBN”), serial number, and other suitable physical object quality or relatedness aspect with the identified object.

The web service preferably establishes and maintains user accounts that records the maintains listings of identified objects associated with the named user or a named persistent pseudonym.

In another optional aspect of the invented method, image recognition technology is used to identify physical objects from their images recognized in digitized image data. In a still other aspect of the invented method, human evaluators are assigned to identify images of physical objects from digitized image data.

In yet another optional aspect of the invented method, a data base maintains records assigned to record information related to physical objects, wherein a first record type \maintains information describing, or related to, an individual instance of a physical object and a second record type maintains information related to a plurality of physical objects that are found to be of a common type, i.e., share a common quality. For example, a type might be defined as a plurality of physical items that are each of a same a model of a shoe. Another type might be defined as a plurality of automobiles that are of a same make, model and year of release into the stream of commerce. A third type might be works of fiction that are authored by writers of a same nation of origin. The data base preferably references user accounts to records of the first record type and the second record type whereby the information stored in these records and accounts may be data mined for relatedness, significance, forensic value, marketing intelligence, behavioral analysis and forecasting value. Assignees or licensees of user accounts may be encouraged by the web service to communicate with each other on the basis of an analysis of the physical objects associated with individual persons as provided to or acquired by the web service, or referenced in a user account.

In another aspect of the invented method, one or more the services of the invented method are offered on the Internet outside of the World Wide Web and/or by alternate electronic communications and computational networks.

The digitized image information may include one or more types of digitized data, such as textual data, visual image data, photographic data, video data, audio data, bar code data, an ISBN and/or other descriptive or identifying information known in the art. The information may be applied in a crowd sourced and/or semi-automated process for the purpose of identifying the item, acquiring information related to the item or its type, securing pricing or marketing guidance, receiving an opinion about or an evaluation of a quality or condition of the item, selecting a sales channel, and/or ranking a plurality of sales channels for relative appropriateness of potential sales channel as a preferred venue for offer of the item.

In an optional aspect of the method of the present invention, guidance is offered to a user of an electronic communications network service, such as a web service provided via the World Wide Web, in acquiring and post processing a digitized image of an item prior to posting a resultant digitized image via the network service. The guidance of this optional aspect of the invented method may include textual or rendered audio prompts that suggest more effective framing and presentation of the item and its elements, such as a prompt to provide a close-up image of the item's tag, or to generate a digitized image of a single view of each element of a collection that constitute the item. The invented system may optionally further enable one-click actions that are applicable to alter a digitized image, or a derive a digitized image from an existing electronic document, that are improve the promotional effectiveness of a resultant digitized image in postings on the Internet or other electronic communications network. For example, the invented system may include a touch screen that enables the generation of close-up images by a motion of a human finger in contact or in proximity with the touch screen. Image cropping and alterations of visuals background may alternatively or additionally be enabled by the invented method, as well as image processing steps known in the art, such as one or more of the image enhancement processes provided by INSTAGRAM™ and other prior art web services that enable the alteration and posting of digitized photographic documents.

Even other optional additional aspects of the invented method include providing a monitoring service of item sales that further notifies a subscriber of the status of items on offer by the subscriber and alerts the subscriber of actions related expected of the subscriber by a marketing agent, purchaser, borrower or leaser of the item. The offer of the item may be an offer for sale, lease, access or loan of the item. The offer may optionally be presented, webcast, advertising or promoted via a website or by a marketing agent. The term “marketing agent” as defined herein includes, and may be, an auction website venture or a marketing website firm.

Additional optional aspects of the invented method support automated process image recognition systems in the identification of objects of certain types. In one alternate aspect, the effectiveness of automated image recognition technology (hereinafter, “IRT”) in recognizing images of three dimensional objects is improved. In some cases, the invented method includes first identifying the type of object to an automated visual image recognition system (hereinafter, the “IRS”), whereupon the object type is used to select a stored and associated photographic guidance image, or “ghost image”, that is associated with the identified type. The selected ghost image is then provided to and rendered by the invented system, or other suitable device, whereby a user is guided by a rendering of the ghost image to place the object in one or more preferred orientations relative to a camera in a process of capturing and storing images of the object. The identification of object type provided to the IRS may specify a generic type of the object, e.g., shoes or silverware, or by make, model and year, e.g., a sneaker style of a certain year of release and made by a particular manufacturer.

In a still other optional aspect of the invented method, a user is instructed or prompted to generate a digitized photo of a label or a manufacturers marking of an object. This source label digitized photo is then image processed to modify this digitized image to increase a likelihood that a resultant digitized image might be more recognizable by the an IRS or IRT.

In a yet other optional aspect of the invented method, the difficulty of IRT and the IRS is recognizing shiny objects, e.g., shiny silverware, is particularly addressed by applying filtering techniques that reduce glare and increase feature contrast of the imaged shiny object, whereby IRS and IRT effectiveness is enhanced in general when provided with images that are less affected by glare.

In an even other optional aspect of the invented method, digitized images are provided to the IRS or IRT, and when the IRS or the IRT fails to, or insufficiently recognizes, an object from analysis of a digitized image or images, one or more of these images are provided to human evaluators who are tasked with identifying the instant object and optionally providing additional relevant information, e.g., pricing guidance. Alternatively or additionally, after the IRS or the IRT sufficiently recognize an object from an analysis of a digitized image or images, the image is provided to human evaluators who provide additional relevant information, e.g., suggestions or recommendations of sales channels to possibly marketing websites.

The invented system may additionally associate a title and description of an identified object within a template selected from a template database, wherein the template is previously assigned to the type of the object. The invented system may further customize, in an automated or a human guided process, on the basis of an analysis of one or more digitized images of the object. When the object is not identified by the IRS or IRT, the digitized images may be provided to a human evaluator who then attempts to identify the object and generate a new template for the instant object. The new template and information contained therein may be stored within the template database. In certain preferred embodiments of the invented process, the template database may include software applicable to publish, render of modify web pages.

In other additional optional aspects of the invented method, a promotional process may be generated to increase visibility of a posting of images of and information related to the object. The intended results of the promotional process might include (a.) increasing rankings of WebPages rendering the object images and related information in search results from commercially available web search engines, e.g., GOOGLE™; (b.) including more effective keywords and web page backlines to facilitate improved rankings in web search engine query results; (c.) automatically posting digitized images of the object and associated information, e.g., object descriptions, keywords and web page back links at selected network servers, web pages, websites and social media websites, such as PINTEREST™, INSTAGRAM™ and FACEBOOK™. Additionally or alternatively, the promotional process may automatically, or as guided and permitted by the user, transmit web links to one or more web pages related to the object, or web pages providing digitized images or information related to the object, (a.) to social media services, e.g., TWITTER™, possibly with appropriate hashtags; (b.) to email addresses found in the user's digitally stored address book; (c.) to social media video posting network services and web sites, e.g., YOUTUBE™, along with video data and/or audio data related to the object; and/or (d.) to audio posting services, e.g., SOUNDCLOUD, along with audio data related to the object. It is understood that items that are abstractions rather than physical objects may also be promoted with visual icon or visual images that may be associated with the non-physical or virtual item.

Still other additional and optional aspects of the invented method, shipping support and/or materials may be provided for use in transporting a sold, leased or loaned item from an offering party and to an accepting party. At one support level, the shipping party may be provided with guidance, possibly including a video presentation, of how to package the relevant object, what packing materials to use and/or where to acquire the packing materials. At another support level, the shipper may be sent a shipping kit that includes packaging materials and packing instructions. At yet another support level, the object may be picked up as is by a shipping support agent, and packaged and shipped by the shipping support agent, acting solely or in concert with other parties, to a destination address. It is understood that the term “packaging materials” as referred to in this disclosure may include boxing, a shell, cushioning material, insulating material, address labels and/or postage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

Figure A is a flowchart of the actions of a networked server processing a request to provide information about an item;

Figure B is a flowchart of the networked server of Figure A processing a request to provide information derived from multiple digitized images of many items;

Figure C is a flow chart of a user engaging with the networked server of Figure A in requesting and receiving information on the basis of providing a digitized image of one or more items;

Figure D is block diagram of several databases of the networked server of Figure A;

Figure E is an illustration of the format of a user account database of Figure D;

Figure F is an exemplary type record of the database of Figure D wherein a plurality of item records are listed and user accounts are cross referenced;

FIG. 1 is a visual representation of a user employing an electronic device to connect with the server of Figure A via an electronic communications network;

FIG. 2 is a diagram of a computer network of the invented service wherein interactions between the device of FIG. 2 and various computational systems enable the various service options and aspects of the invented method;

FIG. 3 is a schematic drawing of the hardware components of the user device of FIG. 1;

FIG. 4 is a top level process chart of the invented method applied to helping users identify and optionally market items as enabled by the invented process of Figure A;

FIG. 5 is a process chart of aspects of the user experience of the invented process of FIG. 4;

FIG. 6 is a marketing web page as published by marketing web server software of the method of FIG. 5;

FIG. 7 is a flow chart of a user interaction by means of the user device with the server via the network of FIG. 2;

FIG. 8A is a block diagram of an exemplary first image record that includes a first image record identifier;

FIG. 8B is a block diagram of an exemplary first initiating message that contains a plurality of image records

FIG. 9 is a flowchart of interaction of the server of Figure A with the user device and the web server of FIG. 2;

FIG. 10A is a block diagram of an exemplary first item record;

FIG. 10B is a block diagram of an exemplary message sent from the server of FIG. 2 to an image recognition technology server;

FIG. 10C is a block diagram of an exemplary message sent the image recognition technology server to the of FIG. 2;

FIG. 10D is a block diagram of an item exemplary evaluation message sent from the server to a crowd source human evaluation server of FIG. 2;

FIG. 10E is a block diagram of an exemplary item evaluation response message that is sent from the crowd source evaluation server 14 and to the server 4;

FIG. 10F is a block diagram of an exemplary first item record message that includes an item record of Figure F;

FIG. 10G is a block diagram of an exemplary second post message that is issued by the user device and directs the server of FIG. 2 as to what and where to offer an item for sale, lease, rental, donation, access or license;

FIG. 10H is a block diagram of an exemplary second marketing message that is issued by the server and addressed to the network address of the marketing website server of FIG. 2;

FIG. 11 is an additional software flowchart of operations of the server of FIG. 2 that are in accordance with certain optional aspects of the invented method;

FIG. 12 is an additional software flowchart of operations of the server of FIG. 2 that are in accordance with certain optional aspects of the invented method of gathering and providing guidance information to the user 1 by adding guidance information into an exemplary first item record;

FIG. 13 is a schematic diagram showing examples of components that may be included in the server;

FIG. 14 is a representation of a web template library 1 as stored in a database management system of the server of FIG. 2;

FIG. 15 is a block diagram of a web template record;

FIG. 16 is a block diagram of the database management system of FIG. 14;

FIG. 17 is a block diagram of a guidance record;

FIG. 18 is a block diagram of an IRT record;

FIG. 19 is a block diagram of a system memory of the user device of FIG. 2;

FIG. 20 is a block diagram of the software of a client device of FIG. 1;

FIG. 21 is a flowchart of a user process in generating an initial message of step A.04;

FIG. 22A is a flow chart of the server in responding to the initial message of FIG. 21;

FIG. 22B is a first response message of the server of FIG. 2 to the initial message of FIG. 21;

FIG. 22 is a flowchart of a population of a web template by a user response and without benefit of guidance;

FIG. 24 is a flowchart of a population of a web template by a user response and with benefit of guidance;

FIG. 25A is a depiction of the mobile device of FIG. 1 visually rendering a right side ghost image of a shoe;

FIG. 25B is a depiction of the mobile device of FIG. 1 visually rendering a right side top edge line image of a shoe;

FIG. 25C is a depiction of the mobile device of FIG. 1 visually rendering a left side ghost image of a shoe;

FIG. 25D is a depiction of the mobile device of FIG. 1 visually rendering a left side top edge line image of a shoe;

FIG. 25E is a depiction of the mobile device of FIG. 1 visually rendering a front view ghost image of shoes;

FIG. 25F is a depiction of the mobile device of FIG. 1 visually rendering a front view top edge line image of shoes;

FIG. 25G is a depiction of the mobile device of FIG. 1 visually rendering a back view ghost image of shoes;

FIG. 25H is a depiction of the mobile device of FIG. 1 visually rendering a back view top edge line image of shoes;

FIG. 25I is a depiction of the mobile device of FIG. 1 visually rendering a top view ghost image of shoes;

FIG. 25J is a depiction of the mobile device of FIG. 1 visually rendering a bottom view ghost image of shoes;

FIG. 25K is a depiction of the mobile device of FIG. 1 visually rendering a tag view ghost image of shoes;

FIG. 25L is a depiction of the mobile device of FIG. 1 visually rendering a top view top edge line image of shoes;

FIG. 25M is a depiction of the mobile device of FIG. 1 visually rendering a bottom view top edge line image of shoes;

FIG. 25N is a depiction of the mobile device of FIG. 1 visually rendering a tag view top edge line image of shoes;

FIG. 26A is a depiction of the mobile device of FIG. 1 visually rendering a front view ghost image of a spoon;

FIG. 26B is a depiction of the mobile device of FIG. 1 visually rendering a side view ghost image of a spoon;

FIG. 26C is a depiction of the mobile device of FIG. 1 visually rendering a bottom view ghost image of a spoon;

FIG. 26D is a depiction of the mobile device of FIG. 1 visually rendering a handle view ghost image of a spoon;

FIG. 26E is a depiction of the mobile device of FIG. 1 visually rendering a front view top edge line image of a spoon;

FIG. 26F is a depiction of the mobile device of FIG. 1 visually rendering a side view top edge line image of a spoon;

FIG. 26G is a depiction of the mobile device of FIG. 1 visually rendering a bottom view top edge line image of a spoon;

FIG. 26H is a depiction of the mobile device of FIG. 1 visually rendering a handle view top edge line image of a spoon;

FIG. 27A is a depiction of the mobile device of FIG. 1 visually rendering a top view ghost image of a plate;

FIG. 27B is a depiction of the mobile device of FIG. 1 visually rendering a bottom view ghost image of a plate;

FIG. 27C is a depiction of the mobile device of FIG. 1 visually rendering a top view top edge line image of a plate;

FIG. 27D is a depiction of the mobile device of FIG. 1 visually rendering a bottom view top edge line image of a plate;

FIG. 27E is a depiction of the mobile device of FIG. 1 visually rendering a tag view ghost image of a plate;

FIG. 27F is a depiction of the mobile device of FIG. 1 visually rendering a close up view ghost image of a plate;

FIG. 27G is a depiction of the mobile device of FIG. 1 visually rendering a tag view top edge line image of a plate;

FIG. 27H is a depiction of the mobile device of FIG. 1 visually rendering a close up view top edge line image of a plate;

FIG. 28A is a depiction of the mobile device of FIG. 1 visually rendering a front view ghost image of a smartphone;

FIG. 28B is a depiction of the mobile device of FIG. 1 visually rendering a side view ghost image of a smartphone;

FIG. 28C is a depiction of the mobile device of FIG. 1 visually rendering a top view ghost image of a smartphone;

FIG. 28D is a depiction of the mobile device of FIG. 1 visually rendering a front view top edge line image of a smartphone;

FIG. 28E is a depiction of the mobile device of FIG. 1 visually rendering a side view top edge line image of a smartphone;

FIG. 28F is a depiction of the mobile device of FIG. 1 visually rendering a top view top edge line image of a smartphone;

FIG. 29A is a depiction of the mobile device of FIG. 1 visually rendering a sample video of a concert ticket;

FIG. 29B is a depiction of the mobile device of FIG. 1 visually rendering a sample narrative of an audio book, audio file; and

FIG. 29C is a depiction of the mobile device of FIG. 1 visually rendering sample pages of an e-book pdf file.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Referring now generally to the Figures and particularly to Figure A and FIG. 1, a user 1 employs electronic devices 2 to connect with a server 4 via an electronic information technology network 6, such as the Internet and optionally in combination with a telephony network as represented in FIG. 1.

Figure A is flow chart of the server 4 interacting with an exemplary user 1 to provide the invented service to the exemplary user 1 (hereinafter, “first user” 1). The invented service accepts information related to items by participants of the network 2. The provided information preferably or includes digitized image data and is analyzed or processed by the server 4 to identify an item by type on the basis of the provided information. In response to the first user 1 submitting data that is identified as an item by the invented service, the server 4 responds by sending information associated with the identified item to the first user 1, to include advice on how to market or acquire the identified item.

In step A.02 the exemplary user 1 either (a.) accesses an account USER.001 previously opened by or assigned to the first user 1 as account holder; or (b.) optionally creates a new user account USER.001 and names the first user 1 as the account holder thereof. It is understood that the invented service applies the server 4 to maintains a server database management system 400 that maintains and updates an account record U.ACC.001 that is assigned to maintain the first user account USER.001, store information related to the first user 1, and to derive and maintain information related to items previously associated with the first user 1 by the server 4, the network 2 or the invented service.

It is also understood that the server 4 preferably maintains and updates a multiplicity of user account records. U.ACCT.001-U.ACCT.00N, item records ITEM.REC.02-ITEM.REC.N, and item type records TYPE.REC.001-TYPE.REC.N in the server database management system 400 (hereinafter, “the server DBMS” 400).

In step A.04 the server 4 preferably receives a first digitized image document IMAGE.001 as uploaded or otherwise provided via the network 2 to the server 4. The server 4 then applies IRT in step A.06 to determine if an item can be automatically identified by the IRT.

It is understood that in the present disclosure makes reference at times to exemplary items 102-110 of FIG. 1, and that these references are made by way of clarity of explanation, and at times for simplicity of explanation, and have no intention of limiting the scope of the claims.

If no item 102-110 can be identified by the IRT in an analysis of the first digitized image document IMAGE.001 (hereinafter, “first image” IMAGE.001) in step A.06, the first image IMAGE.001, or a portion thereof, is electronically transmitted to a human evaluator, or a group of human evaluators, in step A.08. If no human evaluator offers an identification of an item in step A.08, the server 4 proceeds on to step A.10 and perform alternate processing.

In the alternative, if a human evaluator offers an identification of an item 102-110 by reviewing the first image IMAGE.001 and so informs the server 4 in step A.08, the server 4 then determines in step A.10 if an item-type record TYPE.REC.001-ITEM.REC.N exists in the service database management 400.ITEM that applies to the identified item 102-110. If no item-type record TYPE.REC.001-TYPE.REC.N is found in the server DBMS 400 in step A.10, the server 4 proceeds onto step A.12 and to create an item-type record TYPE.REC.001-TYPE.REC.N and associate the item type record TYPE.REC.001-TYPE.REC.N with both the identified item 102-110 and the first user account USER.001, i.e., the user account U.ACCT.001-U.ACCT.N of the enquiring user.

In the alternative, if an item-type record TYPE.REC.001-TYPE.REC.N exists in the server DBMS 400 that matches the identification provided by the human evaluator in step A.08, the server 4 generates a digitized item record ITEM.REC.01-ITEM.REC.N for the identified item 102-110 and includes in the digitized item record ITEM.REC.02-ITEM.REC.N information that is extracted from the item-type record TYPE.REC.01-TYPE.REC.N of the server DBMS 400.

When either the IRT identifies an item in step A.06, or the human evaluator identifies the item 102-110 in step A.08, the server 4 adds information about the identified item 102-110 to the first user account record U.ACCT.001 in step A.16. The server 4 then responds to any further requests from the first user 1 in step A.18 and proceeds on to alternate processing in step A.20.

Referring now to Figure B, it is understood that the first image IMAGE.001 may be a digitized video file and/or include a plurality of digitized visual images or representations of a plurality of objects, wherein the server 4 may cycle through steps A.06 through A.16 and identify a plurality of items in steps A.06 and/or steps A.08, and update the user account U.ACT.001 in executions of step A.16 by including information sourced from the server DBMS 400 in executions of step A.06 and step A.10. In step B.02, if the IRT has or the human evaluator has determined that the first image IMAGE.001 may contain an additional, not yet reported digitized visual representation of an item 102-110, the server will apply the IRT to determine if the additional item is automatically recognized by the IRT in another execution of step A.06. In addition, if the IRT or the human evaluator has determined that the first image IMAGE.001 may contain an additional, not yet reported digitized visual representation of an item 102-110, the server 4 will return to step A.06.

Referring now to Figure C, the server database DBMS 400 maintains a user library 400.USER of user account records U.ACCT.001-U.ACCT.00N, an item library 400.ITEM of item records ITEM.REC.02-ITEM.REC.N, a library 400.ITEM of item type records TYPE.001-TYPE.N, and a IRT library 400.IRT of information technology records IRT.REC.001-IRT.REC.N. Each IRY record IRT.REC.001-IRT.REC.N, maintains a digitized IRT pattern IRT.P.001-IRT.P.N that is compared with digitized images received by the server 4 and applied by IRT technology to attempt to identify an item by type or by precise instantiation of an object or type of object.

Referring now to Figure C, Figure C is a detailed block diagram of the exemplary user account record U.ACCT.001 that identifies the first user 1 as the account holder of the exemplary first account of the invented service. The user account record U.ACCT.00 includes item records ITEM.REC.001-ITEM.REC.N associated with the first user 1.

Referring now generally to the Figures and particularly to FIG. 1, FIG. 1 is a visual representation of a user 1 employing an electronic device 2 to connect with a server 4 via an electronic communications network 6. As presented in FIG. 2, the network 6 bi-directionally communicatively couples the electronic device 2, or “user device” 2, and the server 6 with a plurality of computational systems 8 through 16 that enable the first user 1 to engage with an invented service 100 to market tangible goods 102-108 and/or virtual goods 110. The service 100 of FIG. 1 (hereinafter “the invented service” 100) includes one or more optional aspects of an automatic image recognition service 112, a crowd sourced item evaluation service 114, a web page generation and guidance service 116, a marketing and pricing guidance service 118, a market venue selection and engagement service 120, and an item shipment guidance service 122.

Exemplary objects that may be documented and sold as items as enabled by the invented service 100 include a plate ware 102, a silverware 104, a cellular telephone 106 and a shoe 108. A virtual good, such as a license or a digitized virtual asset, are represented by an icon 110 that is instantiated as a digitized image in an electronic memory and transmitted by electronic messaging.

Referring now generally to the Figures and particularly to FIG. 2, FIG. 2 is a diagram of a computer network 6 of the invented service 100 wherein interactions between the user device 2 and various computational systems 4 & 8-16 enable the various service options and aspects 112-122. A marketing website server 8 posts webpages that may offer goods and service for sale, lease, rental, access, license and/or donation at a set price or as made available in an auction process. The marketing website server may be comprised within commercially available website based marketing service vendors, such as EBAY™, EBID™ ETSY™, BONANZA™, AMAZON™, CRAIGSLIST™, and the like.

A shopping system 10 enables a potential buyer to view webpages published by one or more marketing website servers. An image recognition technology server 12 provides an automated image recognition service 112 by accepting and processing digitized images of objects and applying image recognition technology to identify the object type of objects represented in the digitized images as received. A crowd source evaluation server 14 provides a crowd source evaluation service 114 by accepting digitized images of objects and providing access to the digitized images of objects to a plurality of human/object evaluation servers 16. The human/object evaluation servers 16 (hereinafter, “crowd evaluation servers” 16) enable human evaluators to observe rendered digitized images of objects and provide information, as attested by the human evaluated, related to the digitized object images as rendered by the crowd evaluation servers 16. The marketing guidance server 18 enables the marketing and pricing guidance service 118. The server 4 enables the web page generation and guidance service 116, the market venue selection and engagement service 120, and the item shipment guidance service 122.

Referring now generally to the Figures and particularly to FIG. 3, FIG. 3 is a schematic drawing of the hardware components of the user device 2. The user device 2 preferably comprises a digital camera and is enabled for both wireless communications via (a.) wireless local area network (WLAN) products that communicate in accordance with the one or more suitable standards Institute of Electrical and Electronics Engineers (“IEEE”), such as the IEEE 802.11 standard; and (b.) digital wireless cellular telephony equipment and standards. The user device 2 may be (a.) an IPHONE™ cellular telephone as marketed by Apple, Inc. of Cupertino, Calif.; (b.) an HTC TITAN II™ cellular telephone as marketed by AT&T, Inc. of Dallas, Tex. and running a WINDOWS 7™ operating system as marketed by Microsoft Corporation of Redmond, Wash.; (c.) a GALAXY NEXUS™ smart phone as marketed by Samsung Group of Seoul, Republic of Korea or and running an ANDROID™; (d.) an IPAD™ tablet computer as marketed by Apple, Inc. of Cupertino, Calif.; (e.) a TOUGHPAD™ tablet computer as marketed by Panasonic Corporation of Kadoma, Osaka, Japan and running an ANDROID™ operating system as marketed by Google, Inc. of Mountain View, Calif.; (f.) a network-communications enabled THINKSTATION WORKSTATION™ notebook computer marketed by Lenovo, Inc. of Morrisville, N.C.; (g.) a NIVEUS 5200 computer workstation marketed by Penguin Computing of Fremont, Calif. and running a LINUX™ operating system or a UNIX™ operating system; (h.) a network-communications enabled personal computer configured for running WINDOWS XP™, VISTA™ or WINDOWS 7™ operating system marketed by Microsoft Corporation of Redmond, Wash.; (i.) a MACBOOK PRO™ personal computer as marketed by Apple, Inc. of Cupertino, Calif.; or (j.) other suitable mobile electronic device, wireless communications device, computational system or electronic communications device known in the art. A device CPU 204 is bi-directionally communicatively coupled to the digital camera 202, a user interface module 206, a visual display module 208, a network interface 210 and a user device system memory 212 by an internal communications device bus 214.

The user device system memory 212 stores a database management system software 214, a user device operating system 216, and a user device system software U.SW 218. The user device operating system 216 may be a commercially available operating system software, such as an IOS™ mobile cellular telephone operating system as licensed by Apple, Inc. of Cupertino, Calif. The user device system software U.SW 218 enables the user device 2 to practice the aspects of the invented method as disclosed herein.

The user device DBMS 214 stores a plurality of records, including digitized image records IM.02-IM.N, initiating messages IMSG.02-IMSG.N, item records ITEM.REC.02-ITEM.REC.N and a default web page template software 220. The user device system memory further provides web browser software 222, such as a copy of a SAFARI™ web browser software as licensed and distributed by APPLE, Inc. of Cupertino, Calif., or other suitable software that enables browsing of the World Wide Web, or “web”.

Referring now generally to the Figures and particularly to FIG. 4, FIG. 4 is a top level process chart of the invented process. In step 4.02 the first user 1 generates and/or selects a digitized image record IM.02-IM.N. The first user 1 next directs the user device 2 to format and populate an initiating message IMSG.02-IMSG.N comprising the selected digitized image record IM.02-IM.N and further to transmit the initiating message IMSG.02-IMSG.N from the user device 2 to the server 4. The server 4 accepts the initiating message IMSG.02-IMSG.N in step 4.06 and identifies the item 102-110 pictured in the selected digitized image record IM.02-IM.N of step 4.02 by automated image recognition technology and/or human evaluation. In step 4.08 the server 4 generates and transmits an item record ITEM.REC.02-ITEM.REC.N to the user device 2, the item record ITEM.REC.02-ITEM.REC.N optionally comprising (a.) a web template WBT.02-WBT.N, (b.) guidance in generating additional digitized image records IM.02-IM.N, (c.) pricing and marketing guidance; and/or (d.) item shipping information. The first user 1 then reviews and optionally modifies the item record ITEM.REC.02-ITEM.REC.N in step 4.10 and determines in step 4.12 whether to direct the marketing website server 8 to post a web page WPAGE.01-WPAGE.N comprising at least some of the information provided in the item record ITEM.REC.02-ITEM.REC.N of step 4.08. Step 4.14 is instantiated when the first user 1 directs the market web site server 8 to post the web page WPAGE.01-WPAGE.N of step 4.10 to offer an item 102-110 as being available for purchase, access, donation, rental, and/or license by either directly sending web page software WPSW.01-WPSW.N to the marketing website server 8 or by directing the server 4 to transmit the web page software WPSW.01-WPSW.N to the market web site server 8. in step 4.16 the marketing website server 8 posts the web page software WPSW.01-WPSW.N. The first user 1 then directs the user device 2 in step 4.18 whether to perform another execution of steps 4.02 through 4.16 in concert with the systems and servers 4 & 10-18 of the network 6 or to proceed on to alternate operations of step 4.20.

Referring now generally to the Figures and particularly to FIG. 5, FIG. 5 is a process chart of aspects of the user experience of the invented service. The first user 1 selects an item 102-110 in step 5.02 and then either generates a new image record IM.02-IM.N by means of the digital camera module 202 of the user device 2 or selects a previously or alternately generated image record IM.02-IM.N, wherein the newly generated or selected image record IM.02-IM.N includes one or more digitized visual representations of the selected item 102-110 of step 5.02. In step 5.06 the user device 2 transmits the image records IM.02-IM.N of step 5.04 to the server 4 and receives an identification of the selected item 102-110 in step 5.08 optionally with guidance regarding (a.) how to prepare a webpage software WPSW.01-WPSW.N, (b.) how to price and how and where to market the item 102-110, and/or (c.) how to ship the item 102-110 to a purchaser. The first user 1 then prepares and/or modifies the web page software WPSW.02-WPSW.N in step 5.10 and selects one or more marketing website servers 8 in step 5.12. The first user 1 sets pricing and/or terms of conditions for sale, rental, donation, access or lease of the item 102-110 in step 5.14 and transmits webpage software WPSW.01-WPSW.N and pricing information to selected marketing website servers 102-110 ins step 5.16. The first user 1 then proceeds on to other actions in step 5.18.

Referring now generally to the Figures and particularly to FIG. 6, FIG. 6 is a marketing web page 600 as published by marketing web server software 222 of the marketing website server 8 as rendered on a video display module 208 by a web browser 222 of the user device 2 or other system or server 4 & 8-18 of the network 6. The marketing web server software SW.800 provides the frame 602 and navigation controls 604 and accepts data from item records ITEM.REC.01-ITEM-REC.N provided by the invented service to render information in an item page window 606 related to a selected item 102-110, such as item name 608, an item textual description 610, a price 612, textual seller information 614 and images or visual representations 616, 618 & 620 of the item 102-110. The marketing web server software SW.800 also provides a purchase actuation button 622 that when selected initiates a sales process of the marketing website server 8. An alternate access actuation button 624 initiates an access permission process of the marketing website server 8, e.g., a process that enables leasing, renting, donating or enabling access of or to the item 102-110.

Referring now generally to the Figures and particularly to FIG. 7, FIG. 7 is a flow chart of a user interaction by means of the user device 2 with the server 4 via the network 6. In step 7.02 the first user 1 acquires one or more digitized images IM.02-IM.N, optionally by generating the digitized images IM.02-IM.N from the digital camera module 202 or by upload through the network 2. The one or more digitized images IM.02-IM.N may include a digitized photograph of a physical item 102-108 or a visual representation of the virtual good 110. The first user 1 then directs the user device 2 to generate and populate an initiating message IMSG.02-IMSG containing one or more images IM.01-IM.N in step 7.04 to the server 4. The user device 2 determines in step 7.06 whether the server 4 has returned an item server message SMSG.02-SMSG.N containing an item record ITEM.REC.02-ITEM.REC.N to the user device 2. When the item server message SMSG.02-SMSG.N includes a populated web page template WBT.02-WBT.N, the first user 1 directs the user device 2 to proceed from step 7.06 to step 7.08 and reviews the server-provided template WBT.02-WBT.N and optionally any guidance information GUID.INFO.02-GUID.INFO.N of the item server message SMSG.02-SMSG.N. If the user device 2 receives user approval of the web template WBT.02-WBT.N in step 7.10, the user proceeds from step 7.10 to step 7.12 and to direct the marketing website server 8 to post the original or revised template WBT.02-WBT.N within the web page as an accessible and downloadable web page. The first user 1 then decides in step 7.14 whether to upload an additional image IM.02-IM.N or images in a following execution of step 7.02 into the instant web page template WBT.02-WBT.N, or to direct the user device 2 to proceed on to step 7.16 and to perform alternate computational operations.

In the alternative, when the user does not approve the server-provided web page template WBT.02-WBT.N in step 7.10, the user may modify the web page template WBT.02-WBT.N in step 7.18, and from step 7.18 either return to step 7.08 to review the web page template WBT.02-WBT.N changes of step 7.18, or on to step 7.20 and to store the webpage template WBT.02-WBT.N. The user device 2 proceeds on from step 7.20 to step 7.14.

Referring now generally to the Figures and particularly to FIG. 8A, FIG. 8A is a block diagram of an exemplary first image record IM.01 that includes a first image record identifier IM.REC.ID.01 and a first digitized image data IM.DATA.01. The image record identifier IM.REC.ID.01 uniquely identifies the instant exemplary first image record IM.01 to the user device 2. The first digitized image data IM.DATA.01 may be digitized photographic data generated by either (a.) the digital camera module 208 or (b.) another digitized photographic source. The first digitized image data IM.DATA.01 may be derived from the process of taking a photograph of a tangible good 102-108. In the alternative or in addition, a image data IM.DATA.02-IM.DATA.N may be or include digitized graphic data that when rendered presents an icon representing a virtual good 110.

The exemplary first image record IM.02 may further include (a.) an item identifier ITEM.ID.01 of an item 102-110 represented in the first image data IM.DATA.01; (b.) a first time date stamp TDS.01 indicating the date and time of the generation of the first image record IM.01 and/or the date and time of the generation or acquisition by the user device 2 of the digitized image data IM.DATA.

Referring now generally to the Figures and particularly to FIG. 8B, FIG. 8B is a block diagram of an exemplary first initiating message IMSG.01 that contains a plurality of image records IM.01-IM.06. All of the image records IM.02-IM.06 contained in the exemplary initiating message IMSG.02 preferably contain digitized photographic or graphical representations of a same item 102-110. The exemplary first initiating message IMSG.01 further includes a server network address ADDR.SERVER of the server 4 as an addressee data and a user system network address ADDR.USER of the user device 2 as a sender address. The exemplary first initiating message IMSG.01 additionally may include an initiating message identifier IMSG.ID.01 that uniquely identifies the comprising the exemplary first initiating message IMSG.01 to both the user device 2 and the server 4. The first initiating message IMSG.01 may optionally include a first item identifier ITEM.ID.01 that uniquely identifies a particular item 102-1110 to the user device 2 and the server 4.

Referring now generally to the Figures and particularly to FIGS. 9 and 10A through 10E, FIG. 9 is a flowchart of interaction of the server 4 with the user device 2 and the web server 8. The server 4 receives digitized images IM.DATA in an initiating message IMSG.02-IMSG.N from the user device 2 via the Internet 6 in step 9.02. The server 4 then initiates an item record ITEM.REC.02-ITEM.REC.N and populates the newly created item record ITEM.REC.02-ITEM.REC.N with the receives digitized images IM.DATA, a unique item identifier ITEM.ID and a unique item record identifier ITEM.REC.ID as further explained in the text accompanying FIG. 10A. The server 4 next selects at least one digitized image data IM.DATA from the uploaded image records IM.02-IM.N in step 9.04. The server 4 applies IRT in step 9.06 in an attempt to generate an automated recognition of an item 102-110 presented in one or more selected digitized images IM.DATA. It is understood that the IRT application and finding may be provided by the IRT server 12 or by an internal IRT module 402 native to the server 4. When the IRT returns a type identifier TYPE.ID of an item 102-110 in step 9.06, the server 4 in step 9.08 selects a webpage template WBT.02-WBT.N corresponding to type identifier TYPE.ID of step 9.06 and populates the selected template WBT.02-WBT.N with the uploaded digitized images IM.DATA received step 9.02. The populated web page template WBT.02-WBT.B is then provided to the user device 2 in step 9.10. When the server 4 receives a permission-to-post message PMSG.02-PMSG.N from the user device 2 in step 9.12, the server 4 directs the web server 8 to post the populated web page template WBT.02-WPT.N, as received from and optionally after editing by the user device 2, as an element of the marketing web page 600 in step 9.14. The server 6 then determines in step 9.16 whether to analyze an additional uploaded digitized image or images in a following execution of step 9.04, or to proceed on to step 9.18 and to perform alternate computational operations.

In the alternative, when the remote or local IRT fails to generate an identification of an item 102-110 from an IRT analysis of the uploaded digitized images IM.DATA of step 9.06, the server 4 sends the selected digitized image records IM.02-IM.N within an evaluation message MSG.EVAL.02 via the Internet 8 to the crowd source evaluation server 14 for examination by one or more human evaluators by means of one or more crowd evaluation servers 16 in step 9.20. The server 4 then receives an evaluation response message RMSG.EVAL.02-RMSG.EVAL.N from the evaluation system in step 9.22 and determines in step 9.24 whether (a.) the evaluation response message EMSG.02-EMSG.N provides an item type identifier TYPE.ID that identifies the item 102-110 from the digitized images IM.DATA, and (b.) the instant item type identifier TYPE.ID has a corresponding webpage template WBT.02-WBT.N. When the evaluation response message RMSG.EVAL.02-RMSG.EVAL.N received by the server 4 in step 9.22 is determined by the server 4 in step 9.24 to include a type identifier TYPE.ID referenced by the server 4 to a corresponding web page template WBT.02-WBT.N, the server 4 proceeds from step 9.24 and to step 9.08. When the evaluation response message RMSG.EVAL.02-RMSG.EVAL.N received by the server 4 in step 9.22 is determined by the server 4 in step 9.24 to not provide an item identifier ITEM.ID corresponding to a web page template WBT.02-WBT.N, the server 4 proceeds from step 9.24 to step 9.10.

Referring now to FIG. 10A, FIG. 10A is a block diagram of an exemplary first item record ITEM.REC.02. The first item record ITEM.REC.02 includes an item record identifier ITEM.REC.ID, an item identifier ITEM.ID, a type identifier TYPE.ID if available, one or more image data IM.02-IM.08, a web template WBT.02 when assigned, and guidance data GUID.DATA when available.

Referring now to FIG. 10B, FIG. 10B is a block diagram of an exemplary IRT message MSG.IRT that may be sent from the server 4 to the IRT server 12 in step 9.06. The IRT message MSG.IRT includes an IRT message identifier IRT.MSG.ID, a network address ADDR.IRT of the IRT server 12 as the addressee, the network address ADDR.SERVER of the server 4 as the sender, one or more image records IM.02-IM.08 and the item identifier ITEM.ID.

Referring now to FIG. 10C, FIG. 10C is a block diagram of an IRT response message RMSG.IRT that is sent from the IRT server 12 and to the server 4 also within step 9.06 and includes the finding of an automated image recognition process performed by the IRT server 12 in which the IRT server 12 analysis image data IM.DATA associated with the item identifier ITEM.ID and searches for a sufficient match between the associated image data IM.DATA and an IRT database of digitized visual features that are associated with item type identifiers TYPE.ID. For example, and not meant as limiting, the IRT technology of the IRT server 12 might identify shoes, plateware, cellular phones and a plurality of icons representing virtual goods and other items by make, model, serial number range and other qualities and characteristics as being referred by individual and specific type identifiers TYPE.ID. The IRT response message RMSG.IRT includes an IRT response message identifier RIRT.MSG.ID, the network address ADDR.SERVER of the server 4 as the addressee, the network address ADDR.IRT of the IRT server 12 as the sender, the item identifier ITEM.ID and either a type identifier TYPE.ID or a null value indicator NULL. When the server 4 receives a null value indicator in an IRT response message RMSG.IRT, the server 4 interprets the null value indicator NULL as an indication that the IRT technology has not identified the item 102-110 related to the instant item identifier ITEM.ID and proceeds from step 9.06 to 9.20.

Referring now to FIG. 10D, FIG. 10D is a block diagram of an exemplary evaluation message MSG.EVAL.02 that may be sent from the server 4 to the crowd source evaluation server 14 in step 9.20. The evaluation message MSG.EVAL.02 includes an evaluation message identifier MSG.EVAL.ID, a network address ADDR.CROWD of the crowd source evaluation server 14 as the addressee, the network address ADDR.SERVER of the server 4 as the sender, one or more image records IM.02-IM.08 and the item identifier ITEM.ID.

Referring now to FIG. 10E, FIG. 10E is a block diagram of an exemplary evaluation response message RMSG.EVAL.02 that is sent from the crowd source evaluation server 14 and to the server 4 within step 9.22 and includes the finding of a human recognition process performed and coordinated by the crowd source evaluation server 14 in which the crowd source evaluation server 14 provides image data IM.DATA to one or more evaluation servers 16 and provides findings of this process as provided by human evaluators in the evaluation response message RMSG.EVAL.02. The evaluation response message RMSG.EVAL.02 includes an evaluation response message identifier RMSG.EVAL.ID, the network address ADDR.SERVER of the server 4 as the addressee, the network address ADDR.CROWD of the crowd source evaluation server 14 as the sender, the item identifier ITEM.ID and either a type identifier TYPE.ID or a null value indicator NULL. When the server 4 receives a null value indicator NULL in an evaluation response message identifier RMSG.EVAL.02 in step 9.22, the server 4 interprets the null value indicator NULL as an indication that the human evaluation process has not identified the item 102-110 related to the instant item identifier ITEM.ID and proceeds from step 9.24 to 9.10.

Referring now to FIG. 10F, FIG. 10F is a block diagram of an exemplary first item record message MSG.ITEM.01 that includes an exemplary second item record ITEM.REC.02 as initially generated by the server 4. The exemplary first item record message MSG.ITEM.01 additionally includes an exemplary item record identifier MSG.ITEM.ID, a user device network address ADDR.USER as an addressee, the server network address ADDR.SERVER as the sender address. The exemplary second item record ITEM.REC.01 includes the item identifier ITEM.ID of the associated item 102-110 as received in step 9.02, a type identifier TYPE.ID if provided in either step 9.06 by the IRT source or step 9.22 as provided by a human evaluator, web page template WBT.02, and guidance information GUIDANCE. The guidance information GUIDANCE may include suggestions and prompts regarding (a.) how to provide better digitized images IM.DATA of the associated item 102-110; (b.) how to price the item 102-110 and an indicator of a likelihood of sale at one or more price levels; and/or (c.) which marketing venues and marketing websites to offer the item 102-110.

Referring now to FIG. 10G, FIG. 10G is a block diagram of an exemplary second post message PMSG.02 that is issued by the user device 2 and directs the server 4 as to what and where to offer the item 102-110 for sale, lease, rental, donation, access or license. The exemplary second post message PMSG.02 includes the item identifier ITEM.ID and one or more network addresses of marketing websites, e.g., EBAY™ and ETSY™. The exemplary second post message PMSG.02 further provides pricing and optionally bidding parameter information PRICING and terms and conditions TERMS of the offer of the relevant item 102-110. The web template WBT.02 is provided as edited and modified by the first user 1 via the user device 2 and includes web page formatting data FORMAT.DATA and various data to be posted at the selected marketing websites, including textual data TEXT.DATA audio data AUDIO.DATA, photographic and/or graphics data IMAGE.DATA, and video data VIDEO.DATA. The exemplary second post message PMSG.02 optionally includes a type identifier TYPE.ID of the relevant item 102-110 as provided in either step 9.06 or step 9.22. The exemplary post message PMSG.ITEM.02 additionally includes a post message identifier PMSG.ITEM.ID, the server network address ADDR.SERVER as the addressee and a user device network address ADDR.USER as the sender address.

Referring now to FIG. 10H, FIG. 10H is a block diagram of an exemplary second marketing message MMSG.02 that is issued by the server 4 and addressed to the network address of the marketing website server 8. Each marketing message MMSG.02-MMSG.N preferably carries information that authorizes and enables the marketing website server 8 to offer the item 102-110 for sale, lease, rental, donation, access or license at the webpage 600. The exemplary second market message MMSG.ITEM.02 additionally includes a market message identifier MMSG.ITEM.ID, a marketing website server network address ADDR.MARKET as the addressee and the server network address ADDR.SERVER as the sender address.

The exemplary second market message MMSG.02 includes the item identifier ITEM.ID and optionally the user device network address ADDR.USER. Bidding terms and conditions BID.DATA may also optionally be added as authorized by the user to be applied in an auction process.

The exemplary second market message MMSG.02 further provides pricing information PRICING and terms and conditions TERMS of the offer of the relevant item 102-110. The web template WBT.02 is provided as edited and modified by the first user 1 at the user device 2 and includes web page formatting data FORMAT.DATA and various data to be published by the market website server 8, including textual data TEXT.DATA audio data AUDIO.DATA, photographic and/or graphics data IMAGE.DATA, and video data VIDEO.DATA. The exemplary second market message MMSG.02 optionally includes a type identifier TYPE.ID of the relevant item 102-110 as provided in either step 9.06 or step 9.22.

Referring now generally to the Figures and particularly to FIG. 11, FIG. 11 is an additional software flowchart of operations of the server 4 that are in accordance with certain optional aspects of the invented method. For the purpose of clarification of explanation, and not meant as offering or suggesting limitations, the remainder of this discussion of FIG. 11 will focus on the management of the exemplary first initiating message IMSG.01.

In step 11.02 the server 4 receives the first initiating message IMSG.01 from the user device 2 that associates a particular piece of plate ware 102 with the first item identifier ITEM.ID.01. The server 4 initiates a first item record ITEM.REC.01 in step 11.02 and populates the first item record ITEM.REC.01 with the first item number identifier ITEM.ID.01 and the image records IM.01-IM.08 provided in the received first initiating message IMSG.01.

The server 4 next determines in step 11.04 whether the item 102 referred to in the first initiating message is identifiable by a type identifier TYPE.ID.01-TYPE.N. The server 4 may optionally attempt this identification by applying internal IRT or be referencing the server database management system DBMS 400 for previous type identifications or associations of the first item identifier ITEM.ID.01. When the server 4 can not associate the plate ware 102 or the contents of the image records IM.01-IM.08 with a type identifier TYPE.ID, the server 4 issues messages to the IRT server 12 and/or the crowd source evaluation server 14 in step 11.06 requesting an assignment of a type identifier TYPE.ID to the first item 102. When the server 4 determines in step 11.08 that no type identifier TYPE.ID has been provided by either the IRT server 12 or the crowd source evaluation server 14, the server 4 proceeds on to step 11.10 and reports this failure to the user device 2 and stores the first item record ITEM.REC.01 for possible later access. The server 4 proceeds from step 11.10 to step 11.12 and to perform additional computational processes.

When the first item identifier ITEM.ID.01 is found by the server to be associated with a type identifier TYPE.ID.01-TYPE.ID.N, e.g., a first type identifier TYPE.ID.01, in either step 11.04 or 11.08, the server 4 proceeds on to step 11.10 and determines if an web page template WBT.01-WBT.N or any guidance information associated with the first type identifier TYPE.ID.01 is available as either (a.) stored within or accessible to the server 4; (b.) provided by an external source, e.g., systems or servers of the network 6, i.e. servers 8 & 12-18; (c.) and/or from other suitable digitized information sources known in the art. When a suitable first web page template WBT.01 is found that is associated with the first type identifier TYPE.ID.01, and/or and a first guidance information GUIDANCE.01 related to the first type identifier TYPE.ID.01 is available to the server 4, the server 4 updates the first item record ITEM.REC.01 with the associated information GUIDANCE.01 & WBT.01 in step 11.16.

The first item record ITEM.REC.01 is then transmitted to the user device in step 11.18 in a first item message MSG.ITEM.REC.01, and in the loop of steps 11.20 & 11.22 the server optionally receives updates to the first item record ITEM.REC.01 wherein the first user 1 preferably applies the user device 2 or other suitable device or system known in the art to revise the first item record ITEM.REC.01 on the basis of associated information GUIDANCE.01 & WBT.01 provided in the first item message MSG.ITEM.REC.01 in step 11.18.

The server 4 then determines in step 11.24 whether a post message PMSG.01-PMSG.N has been received from the user device 2 or other suitable device or system known in the art, when a post message PMSG.01-PMSG.N has been received that authorizes the server 4 to derive and transmit a marketing message MMSG.01-MMSG.N to the marketing website server 8, the server 4 proceeds on to step 11.26 and to populate a marketing message MMSG.01-MMSG.N with information from the instant post message PMSG.01-PMSG.N and transmit the derived marketing message MMSG.01-MMSG.N to the marketing website server 8. The server 4 proceeds from step 11.26 or step 11.24 and to perform additional and alternate computational operations.

Referring now generally to the Figures and particularly to FIG. 12, FIG. 12 is an additional software flowchart of operations of the server 4 that are in accordance with certain optional aspects of the invented method of gathering and providing guidance information to the first user 1 by adding guidance information into an exemplary first item record ITEM.REC.01. In step 12.02 the server determines that the first type identifier TYPE.ID.01 has been associated with either the first item identifier ITEM.ID.01 or the first item record ITEM.REC.01. The server 4 optionally sends out requests to the network 6 and servers 8-18 requesting any guidance information that may be related to the first type identifier TYPE.ID.01. If any receipt of externally provided guidance information is detected in step 12.06 by the server 4, the server 4 updates the guidance information GUIDANCE.01 of the first item record ITEM.REC.01 with the externally source guidance information in step 12.08.

The server 4 proceeds from either step 12.06 or step 12.08 to step 12.10 and to determine whether any internally stored guidance information is associated with the first type identifier TYPE.ID.01 of the first item record ITEM.REC.01. When no internally stored guidance information is found by the server 4 in step 12.10, the server 4 proceeds on to step 12.12 and transmits first item record ITEM.REC.01 to the user device 2. Alternatively, when the server 4 in step 12.10 detects internally stored guidance information that is associated with the type identifier TYPE.ID.0, the server 4 proceeds on to step 12.14 to select the guidance information and stores this guidance information into the first item record ITEM.REC.0 in step 12.16. The server 4 then proceeds from step 12.16 to step 12.12 and transmits the first item record ITEM.REC.01 to the user device 2. The loop of steps 12.12, 12.16 & 12.18 enables the server 2 to update the first item record ITEM.REC.01 with revisions and updates received from the user device 2 or via the network 6 and forward on to the user device 2 with revisions of the first item record ITEM.REC.01.

Referring now generally to the Figures and particularly FIG. 13, FIG. 13 is a schematic diagram showing examples of components 402-416 that may be included in the server 4 as may be used in connection with performing the various embodiments of the techniques described herein. The server 4 may include one or more central processing units 402, memories 404, a network interface unit 408, digitized data storage 410, an image recognition technology module 406, and a system bus 411 used to facilitate communications between the components 404-410 of the server 4.

Depending on the configuration and type of server 4, memory 404 may be volatile (such as RAM), non-volatile (such as ROM, flash memory, etc.) or some combination of the two. Additionally, the server 4 may also have additional features/functionality. For example, the server 4 may also include additional storage (removable and/or non-removable) including, but not limited to, USB devices, magnetic or optical disks, or tape. Such additional storage is illustrated in FIG. 11 by storage 410. The digitized data storage 410 of FIG. 2 may include one or more removable and non-removable storage devices having associated computer-readable media that may be utilized by the server 4. The storage 410 in one embodiment may be a mass-storage device with associated computer-readable media providing non-volatile storage for the server 4. Although the description of computer-readable media as illustrated in this example may refer to a mass storage device, such as a hard disk or CD-ROM drive, it will be appreciated by those skilled in the art that the computer-readable media may be any available media that can be accessed by the server 4.

By way of example, and not limitation, computer readable media may comprise computer storage media and communication media. Memory 404, as well as storage 410, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by server 4.

The server 4 may also contain communications connection(s) that allow the computer to communicate with other devices and components such as, by way of example, input devices and output devices.

In one embodiment, the server 4 may operate in a networked environment as illustrated in FIG. 2 using logical connections to remote computers through the network. The server 4 may connect to the network 12 of FIG. 10 through a network interface unit 408 connected to the communications bus 411. The network interface unit 408 may also be utilized in connection with other types of networks and/or remote systems and components.

One or more program modules and/or data files may be included in memory 404. During operation of the server 4, one or more of these elements included in the storage 410 may also reside in a portion of memory 404, such as, for example, RAM for controlling the operation of the server 4. The example of FIG. 13 illustrates various components including an operating system 412, programming modules 416, such as a web browser 420, and other components, inputs, and/or outputs 400.

The operating system 412 may be any one of a variety of commercially available or proprietary operating systems. The operating system 412, for example, may be loaded into memory in connection with controlling operation of the server 4.

Referring now generally to the Figures and particularly to FIG. 14, FIG. 14 is a representation a web template library 1400 as stored in the server DBMS 400 of the server 4, and that may optionally distributed within the network 16 to include the user system 2. The web page template library 1400 includes a plurality of web page template records WBT.REC.01-WBT.REC.N that are each separately associated with a single unique item identifier TYPE.ID.01-TYPE.N.

FIG. 15 is a block diagram of a web template record.

FIG. 16 is a block diagram of the guidance library and several guidance records.

FIG. 17 is a block diagram of a first guidance record.

FIG. 18 is a block diagram of IRT record 1208A, wherein patterns are stored and applied for matching against video or photographic data, and when a match is found an item type associated with the pattern, e.g., when a match with PATTERN.A is found by IRT or an IRS, the server 4 is assigns the item to the type of the MODDEL.A of the same record 1208A.ID.

FIG. 19 is a block diagram of the user device system memory 212 and part of its contents.

FIG. 20 is a block diagram of client software CLIENT.SW of the user device 2.

FIG. 21 is a flow chart of the process of a client system 2 generating an initial message to the server 4 and adding optionally adding text data, image data, video data, and then determining to send a message with data in step 18A.16.

FIG. 22A is a flow chart of the server generating a first response message, wherein the server forms an item record in step 19A.04 and applies template default guidance when the item is not identified in step 19A.06, and adds guidance data in step 19.12.

FIG. 22B is a block diagram of a server first response message.

Referring now generally to the Figures and particularly to FIG. 23, FIG. 23 is a flow chart of a new record generation process of the invented method. In step 2302 a web template associated with the first submitted item is received. Based on the specifics of a template received in step 2302 the user is given choices to submit an image in steps 2304 and 2306, a video in steps 2308 and 2310 and submit a text in steps 2312 and 2314. In step 2316 the user system conducts a check to determine if has received data from user that is sufficient for creating a record. In step 2318 the template is populated with images, and/or video, and/or text submitted by user, and in step 2320 a new record is created, saved in the memory as a new document. In the steps 2322 and 2024 user is given an option to post newly created document on a publically viewable web resource/

Referring now generally to the Figures and particularly to FIG. 24. FIG. 24 is a flow chart of new record generation process of the invented method, with optional assistance provided by a guidance system associated with a particular template. In step 24.02 a template associated with the first submitted item is received. Based on the specifics of a template received in step 24.02 the user is given choices to submit: an image in steps 24.04 and 24.10, a video in steps 24.12 and 24.18, and a text in steps 24.20 and 24.26. Optionally, in steps 24.06, 24.08, 24.14, 24.16, 24.22 and 24.24 user is using a template-associated guidance for assisting user with image, video and text respective submittal processes, i.e., graphical outline of a views of items and ghost images of items as shown in FIGS. 25A through 29C, wherein the data graphical outlines and ghost images of FIGS. 25A-19C were provided in guidance records G.REC.01-G.REC.N sent from the server DBMS 400 to the user device 2.

In step 24.28 the user system conducts a check to determine if it has received data from user that is sufficient for creating a record. In step 24.30 the template is populated with images, and/or video, and/or text submitted by user, and in step 24.32 a new record is created, saved in the memory as a new document. In the steps 24.34 and 2440 user is given an option to post newly created document on a publically viewable web resource/site. Optionally, in steps 24.36 and 24.38 user is using a template-associated guidance for assisting user with the new document posting process.

FIGS. 25A through 29C are depictions of ghost data being rendered on the user's device 2. The ghost images were sourced from guidance records G.REC.01-G.REC.N.

In the invented method, the user is enabled, and in some cases preferably directed to, position an item 102-110 for capturing an image with the user device 2 by matching a shaded or ghost area or a graphical outline of a view of an article, of the screen with an image of the item. This process is often beneficial to IRT, as IRT can compare patterns of images within known constraints rather than in unexpected visual contexts.

The foregoing disclosures and statements are illustrative only of the Present Invention, and are not intended to limit or define the scope of the Present Invention. The above description is intended to be illustrative and not restrictive. Although the examples given herein include many specificities, they are intended as illustrative of only certain possible configurations or aspects of the Present Invention. The examples given should only be interpreted as illustrations of some of the preferred configurations or aspects of the Present Invention and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

I claim:

1. In an electronic communications network (“the network”), a method comprising:
a. Capturing a digitized image of an article;
b. Posting the digitized image at an evaluation website;
c. Receiving a descriptive datum associated with the article from the network; and
d. Posting the digitized image at a sales website in association with an information at least partly derived from the descriptive datum.

2. The method of claim 1, further comprising a human generation of the information in view of the descriptive datum.

3. The method of claim 1, wherein the digitized image is a video file.

4. The method of claim 1, wherein the sales website is an auction website.

5. The method of claim 1, wherein the descriptive datum is a pricing recommendation.

6. The method of claim 5, wherein the pricing recommendation comprises a pricing range.

7. The method of claim 1, wherein the descriptive datum specifies a quality level of the article.

8. The method of claim 1, wherein the descriptive datum specifies a provenance of the article.

9. The method of claim 1, wherein the article is a silverware.

10. The method of claim 1, wherein the article is a shoe.

11. The method of claim 1, wherein the network comprises the Internet.

12. The method of claim 1, further comprising providing a network-enabled mobile device comprising a digital camera and capturing the digitized image by means of the digital camera.

13. The method of claim 1, further comprising post processing the digitized image to generate an enhanced digitized image and posting the enhanced digitized image at the sales website.

14. In an electronic communications network (“the network”) comprising at least a and data base server and a client system having a digitized camera, a method comprising:
a. Storing at least one digitized graphical outline of a view of an article within the network;
b. Receipt by the data base server of an identifier of the article;
c. Transmission of the at least one digitized graphical outline to the client system; and
d. Receipt from the client system by the network of a digitized image associated with the identifier of the article.

15. The method of claim 15, wherein the client system is a network-enabled mobile device.

16. The method of claim 15, wherein the digitized image is a video file.

17. The method of claim 15, wherein a plurality of visually distinguishable articles are associated with separate digitized graphical outlines, and the separate digitized graphical outlines are stored within the network and accessible to the data base server.

18. The method of claim 15, further comprising:
a. Storing within the network a second digitized graphical outline associated with the article;
b. Transmission of the second digitized graphical outline to the client system; and
c. Receipt from the client system by the network of a second digitized image associated with the identifier of the article.

19. The method of claim 19, further comprising associating the at least one digitized graphical outline with the second digitized image.

20. The method of claim 19, wherein the at least one digitized image is posted at a sales website.

21. The method of claim 21, wherein the sales website is an auction website.

22. The method of claim 19, further comprising:
a. Posting the at least one digitized image at an evaluation website;
b. Receiving a descriptive datum associated with the article from the network; and
c. Posting the digitized image at the sales website in association with an information at least partly derived from the descriptive datum.

23. The method of claim 22, wherein the descriptive datum comprises a pricing information.

24. The method of claim 22, wherein the descriptive datum comprises a quality valuation of the article.

25. The method of claim 22, further comprising post processing the digitized image to generate an enhanced digitized image and posting the enhanced digitized image at the evaluation website.

26. A system comprising:
a. Means to capture a digitized image of an article;
b. Means to post the digitized image at an evaluation website;
c. Means to receive a descriptive datum associated with the article from the network; and
d. Means to post the digitized image at a website in association with an information at least partly derived from the descriptive datum.

27. A method comprising:
a. Generating a digitized image document of a plurality of articles;
b. Submitting the digitized image to an automated identification and evaluation system;
c. Receiving a plurality of discrete evaluation information from the automated identification and evaluation system, wherein each discrete evaluation information is individually associated with at least one identified article; and
d. Digitally storing elements of the digitized image document in association with at least one information of the plurality of discrete evaluation information;
e. Enabling access to the digitally stored elements of the digitized image document via an electronic communications network.

28. The method of claim 29, further comprising:
d. Relating the at least one information to a data record accessible to the electronics communications network;
e. Deriving a recommendation of utility of an article associated with the least one information on the basis of the data record; and
f. Communicating the recommendation of utility to a human operator.
